(19) United States
(12) Patent Application Publication
(10) Pub. No.: US 2025/0099789 A1
(43) Pub. Date: Mar. 27, 2025

(54) Battery Extinguishing Device

(71) Applicant: FIREKIM Energy Solution CO., Ltd, Chungcheongbuk-do (KR)

(72) Inventor: Byung Yul KIM, Chungcheongbuk-do (KR)

(73) Assignee: FIREKIM Energy Solution CO., Ltd, Chungcheongbuk-do (KR)

(21) Appl. No.: 18/390,337

(22) Filed: Dec. 20, 2023

(30) Foreign Application Priority Data
Sep. 22, 2023 (KR) 10-2023-0127216

(51) Int. Cl. A62C 2/06; A62C 3/16

(52) U.S. Cl. CPC A62C 2/06; A62C 3/16

(57) ABSTRACT

A battery extinguishing device is provided. The battery extinguishing device includes a fire extinguishing unit including a body having a sheet shape and provided between a plurality of battery cells and a plurality of fire extinguishing portions provided on one side of the body and configured to accommodate a fire extinguishing substance that vaporizes by heat, and a heat blocking portion made of aluminum provided on the body opposite the plurality of fire extinguishing portions and configured to block heat transfer from the plurality of battery cells.

### CROSS-REFERENCE TO RELATED APPLICATION

This application claims the benefit of Korean Patent Application No. 10-2023-0127216 filed on Sep. 22, 2023, in the Korean Intellectual Property Office, the entire disclosure of which is incorporated herein by reference for all purposes.

### BACKGROUND

### 1. Field of the Invention

One or more embodiments relate to a battery extinguishing device.

### 2. Description of the Related Art

As the demand for a portable electronic product such as a laptop, video camera, and portable phone is rapidly increasing and the development of an electric vehicle, energy storage battery, robot, and satellite is in active progress, research on a high-performance rechargeable battery is being actively conducted.

When a battery overheats due to its usage environment or its own aging, the battery explodes and causes a fire. Conventional battery fire extinguishing devices are provided around a plurality of batteries and extinguish a fire by discharging fire extinguishing substances to a battery in which a fire occurs. However, since the conventional battery fire extinguishing devices are configured to discharge fire extinguishing substances only after detecting a fire, a battery that has not started a flame but has been overheated may generate radiant heat, which may be transferred to surrounding batteries, causing extensive explosion and flames.

Thus, there is a need for battery extinguishing technology that is capable of blocking transfer of radiant heat between a plurality of overheated batteries as well as suppressing a battery fire.

The above description has been possessed or acquired by the inventor(s) in the course of conceiving the present disclosure and is not necessarily an art publicly known before the present application is filed.

### SUMMARY

Embodiments provide a battery extinguishing device that may block transfer of radiant heat between a plurality of overheated batteries as well as suppress a battery fire.

The technical goals to be obtained from the embodiments are not limited to the above-mentioned technical goals, and other unmentioned technical goals may be clearly understood from the following description by one of ordinary skill in the art to which the present disclosure pertains.

A battery extinguishing device according to an embodiment is described. The battery extinguishing device includes a fire extinguishing unit including a body having a sheet shape and provided between a plurality of battery cells and a plurality of fire extinguishing portions provided on one side of the body and configured to accommodate a fire extinguishing substance that vaporizes by heat, and a heat blocking portion made of aluminum provided on the body opposite the plurality of fire extinguishing portions and configured to block heat transfer from the plurality of battery cells.

The heat blocking portion may be formed in a form of a substrate or a film and may have a size corresponding to the plurality of battery cells or be provided in plural pieces. A side of the heat blocking portion facing the plurality of battery cells may be blackened to absorb transferred heat.

The plurality of fire extinguishing portions may be formed in a form of a plurality of capsules arranged in a matrix form, and the plurality of capsules may be configured to be destroyed when the plurality of fire extinguishing portions is exposed to a flame or reaches a predetermined temperature or higher.

The fire extinguishing unit may be provided in plural pieces and the battery extinguishing device may further include a coupling portion configured to couple the plurality of fire extinguishing units to face each other.

The coupling portion may be formed in a form of a frame made of a non-flammable or flame-retardant material.

The heat blocking portion may be provided in one of fire extinguishing units, among the plurality of fire extinguishing units, that are provided on both outer sides of the coupling portion.

Additional aspects of embodiments will be set forth in part in the description which follows and, in part, will be apparent from the description, or may be learned by practice of the disclosure.

According to embodiments, a battery extinguishing device may block transfer of radiant heat as well as suppress a battery cell fire through a fire extinguishing unit and a heat blocking portion.

The effects of the battery extinguishing device according to embodiments are not limited to the above-mentioned effect and other effects may be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view of a battery extinguishing device provided in a battery unit, according to an embodiment;

FIGS. 2A and 2B are respectively an exploded perspective view and a perspective view of the battery extinguishing device, according to an embodiment;

FIGS. 3A and 3B are respectively an exploded perspective view and a perspective view of a battery extinguishing device, according to another embodiment; and

FIGS. 4A and 4B are respectively an exploded perspective view and a perspective view of a battery extinguishing device, according to another embodiment.

### DETAILED DESCRIPTION

Hereinafter, embodiments are described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It should be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical or scientific terms used herein have the same meaning as those commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto is omitted. In the description of embodiments, detailed description of well-known related structures or functions is omitted when it is deemed that such description may cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, the orders, or the like of the components are not limited by the terms. It is to be understood that if a component is described as being “connected,” “coupled,” or “joined” to another component, the former may be directly “connected,” “coupled,” or “joined” to the latter or “connected,” “coupled,” or “joined” to the latter via another component.

The same name may be used to describe components having a common function in different embodiments. Unless otherwise mentioned, the description of one embodiment may be applicable to another embodiment. Thus, duplicated description is omitted for conciseness.

Hereinafter, a battery extinguishing device 10 is described with reference to the drawings.

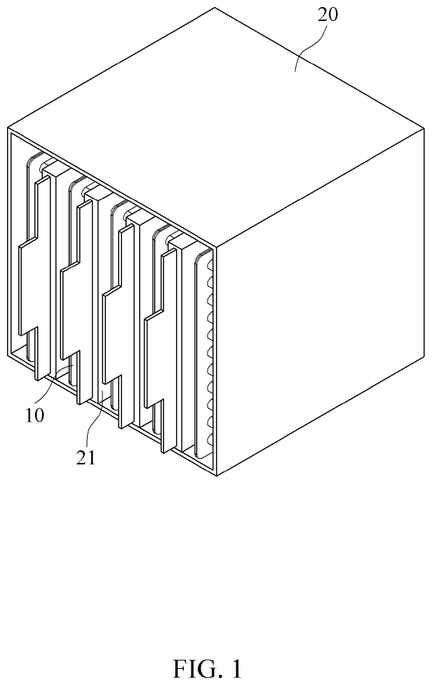

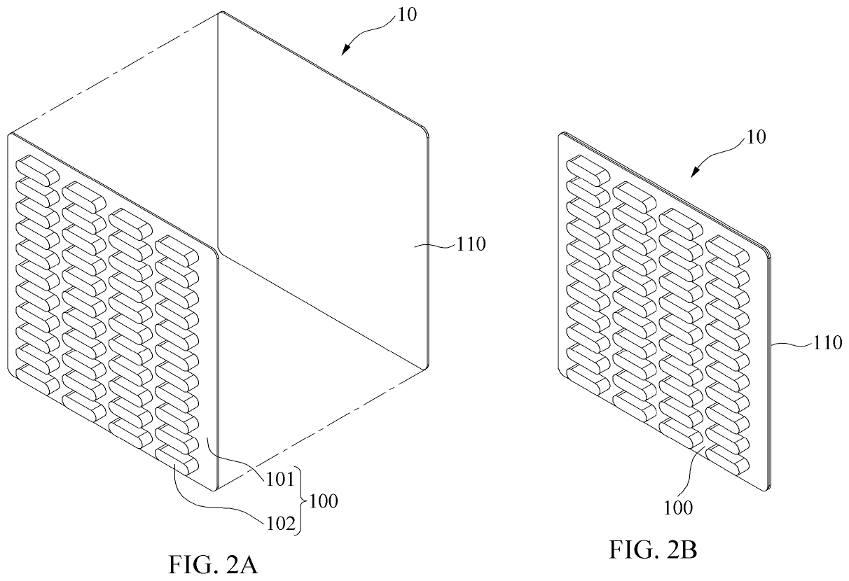

For reference, FIG. 1 a perspective view of the battery extinguishing device 10 provided in a battery unit 20, according to an embodiment, and FIGS. 2A and 2B are respectively an exploded perspective view and a perspective view of the battery extinguishing device 10, according to an embodiment.

The battery extinguishing device 10 may include a fire extinguishing unit 100 and a heat blocking portion 110.

The fire extinguishing unit 100 may include a body 101 and a plurality of fire extinguishing portions 102.

The body 101 may have a sheet shape provided between a plurality of battery cells 21 provided in the battery unit 20. For example, the body 101 may be formed in a circular or polygonal sheet shape to provide a surface on which the plurality of fire extinguishing portions 102 may be placed. Here, the body 101 having a sheet shape may easily be changed in size and thus easily be made smaller or larger according to the structure and shape of the battery unit 20. In addition, the body 101 may be formed to have a thickness that is less than the gap between the plurality of battery cells 21. Specifically, the body 101 may desirably be formed to have a thickness that is not pressurized by two adjacent battery cells 21. In this configuration, since the body 101 is not in contact with the battery cells 21, heat from the battery cells 21 may be prevented from being transferred to the surroundings through the body 101. In addition, the body 101 may be made of a material having high thermal resistance to prevent heat transfer. For example, the body 101 may be made of high molecular polymer, ceramic, tungsten alloy, and the like.

The plurality of fire extinguishing portions 102 may be provided on one side of the body 101 and may accommodate a fire extinguishing substance vaporized by heat. Here, the fire extinguishing portions 102 may be formed in the form of a plurality of capsules that may be destroyed when the fire extinguishing portions 102 are exposed to a flame or reach a predetermined temperature or higher. That is, when a fire occurs, the capsules of the fire extinguishing portions 102 in the form of capsules may be destroyed and the fire extinguishing substance may be released. In this configuration, since the fire extinguishing portions 102 may spread and discharge the entire amount of the fire extinguishing substance at once, the fire suppression rate may be faster and the fire suppression range may be greater than the nozzle method.

The plurality of fire extinguishing portions 102 may be in the form of the plurality of capsules arranged in a matrix form. For example, each of the plurality of fire extinguishing portions 102 may be arranged in a matrix form with intervals determined by considering the emission range of the fire extinguishing substance. In this configuration, since the plurality of fire extinguishing portions 102 may form a fire extinguishing area that evenly covers the entire surface of the battery cells 21, fire suppression efficiency may be improved.

The fire extinguishing portions 102 may include a multilayer film. For example, the fire extinguishing portions 102 may be formed of an inner layer including polypropylene (PP), oriented polypropylene (OPP), polyvinyl chloride (PVC), and polyethylene terephthalate (PET) and an outer layer including an aluminum film that protects the fire extinguishing substance from ultraviolet rays.

The fire extinguishing substance may be a substance that vaporizes when a fire occurs and is used to extinguish the fire and may be in powder form. For example, the fire extinguishing substance may be a substance that expands at 80° C. to 120° C. and becomes gaseous. In addition, the fire extinguishing substance may include fluorinated ketone. Fluorinated ketone is colorless and odorless and has a viscosity similar to water. However, fluorinated ketone has stable properties, and thus has an advantage that it does not conduct electricity when contacting electronic products and that less oxidation occurs in a substance in contact with fluorinated ketone. In addition, since fluorinated ketone quickly evaporates upon contact with heat, it can remove the heat from the scene of a fire when sprayed at the scene but may not remain on objects. Thus, fluorinated ketone may be effectively used, particularly in extinguishing a fire caused by electronic products.

The heat blocking portion 110 may be provided on the body 101 opposite the fire extinguishing portions and made of aluminum to block heat transfer from the battery cells 21. Here, the heat blocking portion 110 may be formed in the form of a substrate or a film and may have a size corresponding to the battery cells 21 or be provided in plural pieces in the body 101. That is, the heat blocking portion 110 may form a blocking wall made of aluminum between the fire extinguishing portions 102 and the battery cells 21, and the heat blocking area may correspond to the size of the battery cells 21 so that the heat transfer from the battery cells 21 may be completely blocked. In addition, since the heat blocking portion 110 may be provided on the body 101 and thus be positioned between the plurality of battery cells 21, the heat blocking portion 110 may block transfer of radiant heat generated between the plurality of battery cells 21.

A side of the heat blocking portion 110 facing the battery cells 21 may be blackened to absorb transferred heat. For example, the side of the heat blocking portion 110 may be surface-treated with black paint and absorb radiant heat to block heat transfer to the surroundings.

The heat blocking portion 110 may be formed to have a thickness that is less than the gap between the body 101 and the battery cells 21. Specifically, the heat blocking portion 110 may desirably be formed to have a thickness that, when provided in the body 101, is not pressurized by two adjacent battery cells 21.

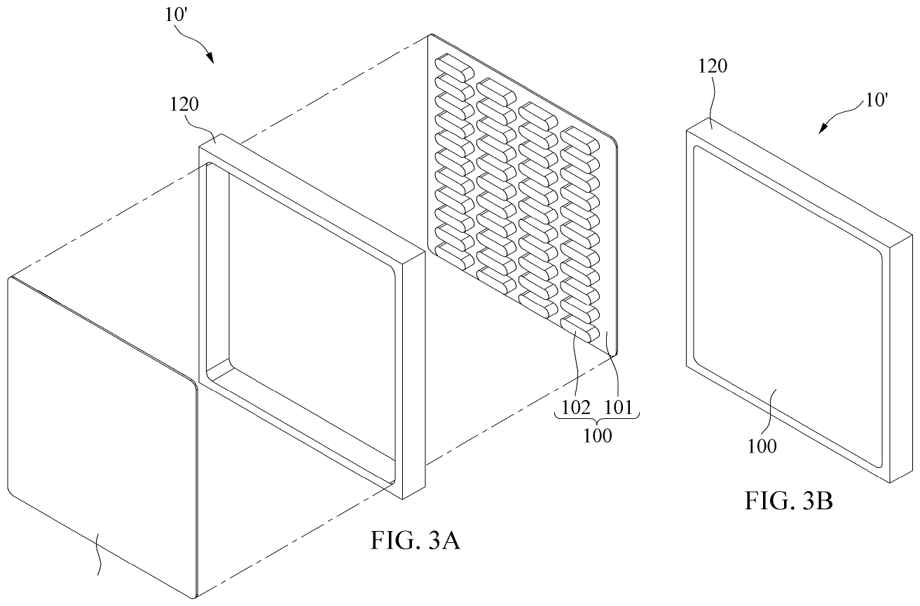

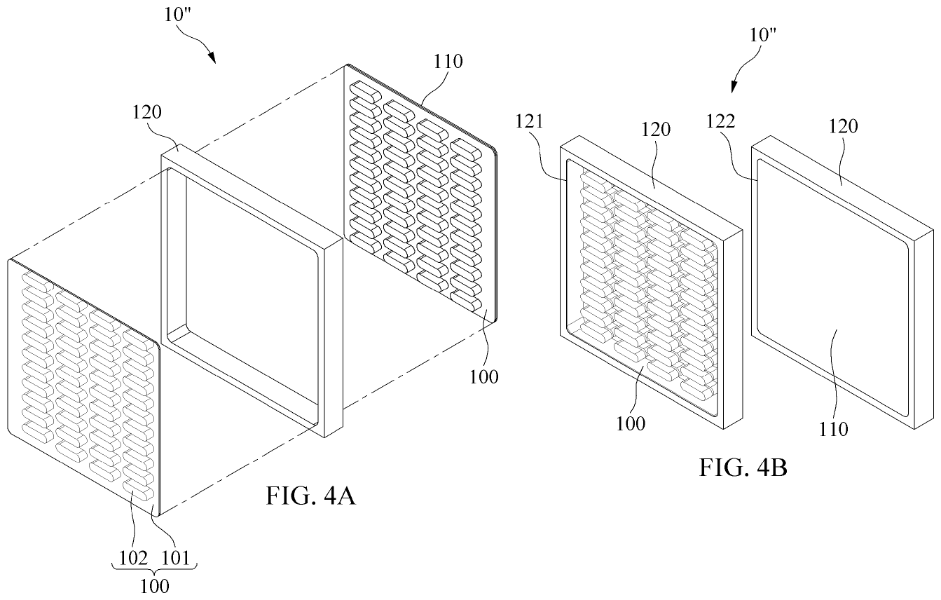

Hereinafter, a battery extinguishing device 10′ and a battery extinguishing device 10″ are described with reference to FIGS. 3A and 3B and FIGS. 4A and 4B, respectively. For reference, FIGS. 3A and 3B are respectively an exploded perspective view and a perspective view of the battery extinguishing device 10′, and FIGS. 4A and 4B are respectively an exploded perspective view and a perspective view of the battery extinguishing device 10″. Description of components identical to or excluded from the battery extinguishing device 10 is omitted.

The battery extinguishing device 10′ may include a plurality of fire extinguishing units 100 and a coupling portion 120.

The coupling portion 120 may couple the plurality of fire extinguishing units 100 to face each other. Here, the coupling portion 120 may couple the plurality of fire extinguishing units 100 so that each of the fire extinguishing portions 102 of each of the plurality of fire extinguishing units 100 may face the same battery cell among the battery cells 21 or face different battery cells among the battery cells 21. In addition, the coupling portion 120 may couple the plurality of fire extinguishing units 100 to be spaced apart from each other, and the intervals between the plurality of fire extinguishing units 100 may be determined according to the emission range of a fire extinguishing substance. For example, when the fire extinguishing portions 102 of the plurality of fire extinguishing units 100 face the same battery cell among the battery cells 21, the coupling portion 120 may couple one of the fire extinguishing units 100 including a fire extinguishing substance having a short emission range to a front surface 121 of the coupling portion 120 and couple another of the fire extinguishing units 100 including a fire extinguishing substance having a long emission range to a rear surface 122 of the coupling unit 120. Accordingly, the two of the fire extinguishing units 100 coupled to the coupling portion 120 may not only release a large amount of the fire extinguishing substance to the battery cells 21 but also release the fire extinguishing substance in a staggered manner, and as a result, the generation of residual embers may be prevented. On the contrary, when the fire extinguishing portions 102 of the plurality of fire extinguishing units 100 face different battery cells among the battery cells 21, the fire extinguishing substance may be released in all directions and the spread of a flame may be suppressed or prevented. In addition, the coupling portion 120 may have a form combining the two cases described above.

The battery extinguishing device 10″ may include the plurality of fire extinguishing units 100, the heat blocking portion 110, and the coupling portion 120.

Here, the coupling portion 120 may be formed in the form of a frame made of a non-flammable or flame-retardant material, and the heat blocking portion 110 may be provided in one of fire extinguishing units 100, among the plurality of fire extinguishing units 100, that are provided on both outer sides of the coupling portion 120. An operation example of the battery extinguishing device 10″ may be the same as that of the battery fire extinguishing device 10′. In the battery extinguishing device 10″, the heat blocking portion 110 may be added so that both blocking radiant heat and releasing a large amount of a fire extinguishing substance may be performed and the coupling portion 120 may be formed of a non-flammable or flame-retardant material so that the spread of a flame may be effectively prevented.

In this embodiment, the battery extinguishing device 10″ may block transfer of radiant heat as well as suppress a fire from battery cells 21 through the fire extinguishing unit 100 and the heat blocking portion 110.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A battery extinguishing device comprising:
a fire extinguishing unit comprising:
a body having a sheet shape and provided between a plurality of battery cells; and
a plurality of fire extinguishing portions provided on one side of the body and configured to accommodate a fire extinguishing substance that vaporizes by heat; and
a heat blocking portion made of aluminum provided on the body opposite the plurality of fire extinguishing portions and configured to block heat transfer from the plurality of battery cells.

2. The battery extinguishing device of claim 1, wherein
the heat blocking portion is formed in a form of a substrate or a film.

3. The battery extinguishing device of claim 1, wherein
the heat blocking portion has a size corresponding to the plurality of battery cells or is provided in plural pieces.

4. The battery extinguishing device of claim 1, wherein
a side of the heat blocking portion facing the plurality of battery cells is blackened to absorb transferred heat.

5. The battery extinguishing device of claim 1,
wherein the plurality of fire extinguishing portions is formed in a form of a plurality of capsules arranged in a matrix form, and
wherein the plurality of capsules is configured to be destroyed when the plurality of fire extinguishing portions is exposed to a flame or reaches a predetermined temperature or higher.

6. The battery extinguishing device of claim 1, wherein
the fire extinguishing unit is provided in plural pieces, and
the battery extinguishing device further comprises:
a coupling portion configured to couple the plurality of fire extinguishing units to face each other.

7. The battery extinguishing device of claim 6, wherein
the coupling portion is formed in a form of a frame made of a non-flammable or flame-retardant material.

8. The battery extinguishing device of claim 6, wherein
the heat blocking portion is provided in one of fire extinguishing units, among the plurality of fire extinguishing units, that are provided on both outer sides of the coupling portion.
